(19) United States
(12) Patent Application Publication
(10) Pub. No.: US 2011/0215596 A1
(43) Pub. Date: Sep. 8, 2011

(54) CABINET LATCH

(75) Inventor: Stephen H. Fagan, Wichita, KS (US)

(73) Assignee: DeCrane Aerospace, Inc., Scottsdale, AZ (US)

(21) Appl. No.: 12/716,872

(22) Filed: Mar. 3, 2010

(51) Int. Cl. E05C 19/12

(52) U.S. Cl. 292/128

(57) ABSTRACT

A latch for securing a cabinet door to a cabinet body is disclosed. The latch includes a cam and cam follower configured to move in a pivoting manner to engage and disengage a hook to and from a striker. All the working parts of the latch are installed inside the cabinet such that they are hidden from view, whether the drawer is opened or closed. To prevent the striker from punching through the cabinet door and damaging the decorative bezel or button situated at the external side of the door, the internal side of the door defines a pocket that provides an integrated striker stop to receive the striker when the cabinet is closed. The decorative bezel or button may be detached and replaced independent of the latch.

### BACKGROUND

1. Field of the Invention

Embodiments of the present invention relate to an apparatus for securing a door. Specifically, the embodiments of the present invention relate to a cabinet latch configured in a cam and cam follower arrangement.

2. Description of the Related Art

Cabinets used to hold items can have an internal latch mechanism for securing the door in a closed position. This feature ensures that the door will not open simply because the cabinet is jostled, for example, while in an airplane during take off, landing, or turbulence. To release the latch and gain access to contents contained in the cabinet, a user must activate a release mechanism of the latch that allows the cabinet door to open.

For instance, one type of latch is a sliding bolt latch. This type of latch requires a lot of clearance for the sliding parts and creates a fair amount of friction during use over time, requiring the user to exert a considerable amount of force to open and close the cabinet door. Furthermore, because the user is more inclined to slam the cabinet door shut to ensure that it is securely closed on the first try, a striker of the latch protruding from the cabinet body is forcibly and repeatedly punched against the internal side of the cabinet door. The door may be coated with a decorative veneer that is aesthetically pleasing, but fragile and easily damaged. Eventually, the striker will punch through the door, damaging not only the door, but a decorative design at the external side of the door.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1A is a diagram of an exterior isometric view of one embodiment of a cabinet door and latch (push to release).

FIG. 1B is a diagram of an exterior side view of one embodiment of a cabinet door and latch.

FIG. 2A is a diagram of a cross-sectional isometric view of one embodiment of a cabinet door and latch.

FIG. 2B is a diagram of a cross-sectional side view of one embodiment of a cabinet door and latch.

FIG. 3A is a diagram of an exterior isometric view of one embodiment of a latch housing with striker stop and striker.

FIG. 3B is a diagram of a cross-sectional isometric view of one embodiment of a latch housing with striker stop and striker.

FIG. 3C is a diagram of a cross-sectional top view of one embodiment of a latch housing with striker stop and striker.

FIG. 4A is a diagram of an exterior isometric view of one embodiment of a button and bezel.

FIG. 4B is a diagram of an interior isometric view of one embodiment of a button and bezel.

FIG. 5 is a diagram of a cross-sectional side view of one embodiment of a cabinet door and latch (pull to release).

FIG. 6 is a diagram of a cross-sectional side view of one embodiment of a cabinet door with a single actuator and two latches.

FIG. 7 is a diagram of a cross-sectional side view of one embodiment of a cabinet door and latch with the actuator on the door positioned away from the latch.

FIG. 8 is a diagram of a cross-sectional side view of one embodiment of a cabinet door using a bellcrank to release multiple bolts.

### DETAILED DESCRIPTION

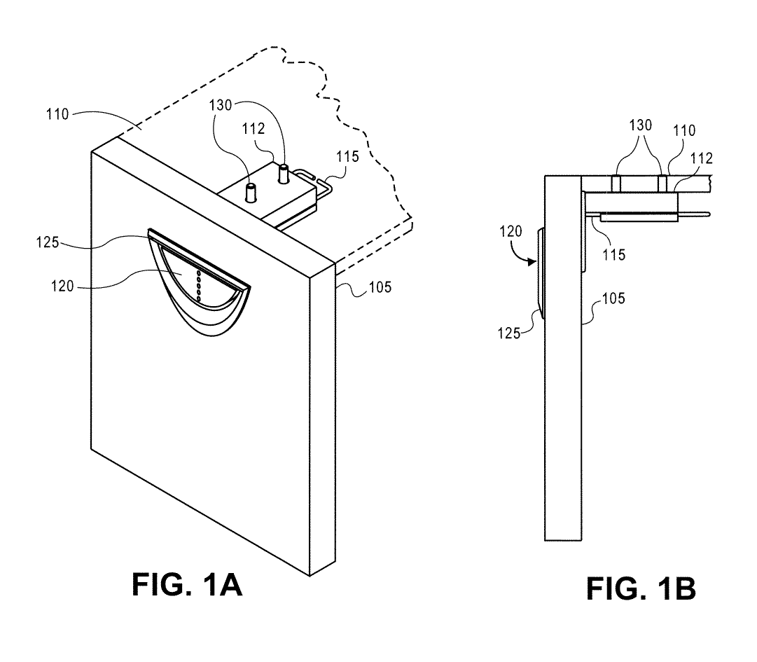

FIG. 1A is a diagram of an exterior isometric view and FIG. 1B is a diagram of an exterior side view of one embodiment of a cabinet latch for a door or drawer. As used herein, “cabinet” is intended to be broad enough to include closets and pull out drawers.

From an external view, the cabinet door includes a first panel 105 that is the main structural piece of the door. The first panel 105 and the second panel 110 are secured together by a latch, which is housed within the first panel 105 and concealed from view. The second panel 110 is the upper ceiling of a cabinet. In another embodiment, the second panel 110 may be a side or bottom wall of the cabinet. In these views, the first panel 105 and the second panel 110 are engaged by the latch, i.e., the cabinet would be closed. The first panel 105 and second panel 110 can be made of plastic, wood, metal, or other solid material. The latch prevents a closed cabinet from opening when the cabinet is jostled or bumped, such as on an airplane. The latch can be released upon activation of an actuator 120 residing on the first panel 105. The physical location of the actuator 120 on the cabinet may differ in other embodiments depending on the configuration of the cabinet and latch.

The second panel 110 secures a striker 115 in position with a spacer 112. The spacer 112 is attached to the second panel 110 with screws 130 and holds the striker 115 in correct alignment with an opening of the first panel 105. The spacer 112 can be shorter or taller in height to position the striker 115 closer to or farther from the second panel 110, respectively, depending on where the striker 115 should be received in the first panel 105. The striker 115 can be secured in another manner, such as by glue or welding. The striker 115 is a solid piece of wire approximately 1/16 of an inch thick formed into a rectangular shape that remains static in position while the first panel 105 moves towards the second panel 110 as the cabinet door is closing. The striker 115 can be formed into a different size or shape to correspond to the particular latch and cabinet used. The first panel 105 defines an opening to receive an end portion of the striker 115 protruding from the second panel 110. The striker 115 is secured inside the first panel 105 when the first panel 105 and the second panel 110 meet.

The actuator 120 can be a push button type. The push button actuator 120 and a bezel 125 surrounding the actuator 120 reside at an outer surface of the first panel 105 of the cabinet door. The bezel 125 is a decorative piece only. The button 120, while also a decorative piece, serves as the physical contact point for a user to initiate activation of the actuator 120 that releases the latch contained in the first panel 105. To open the cabinet, the user presses the button 120 and slides the drawer out. If the user does not press the button 120, the cabinet will not open because the latch inside the cabinet has not been released and thus the first panel 105 and the second panel 110 remain secured together. In another embodiment, the actuator 120 can be of another type, such as a paddle with pull activation or a sensor with touch activation. The latch may be used in embodiments other than sliding drawer cabinets, such as hinged doors or side sliding doors (e.g., screen doors that slide to the side).

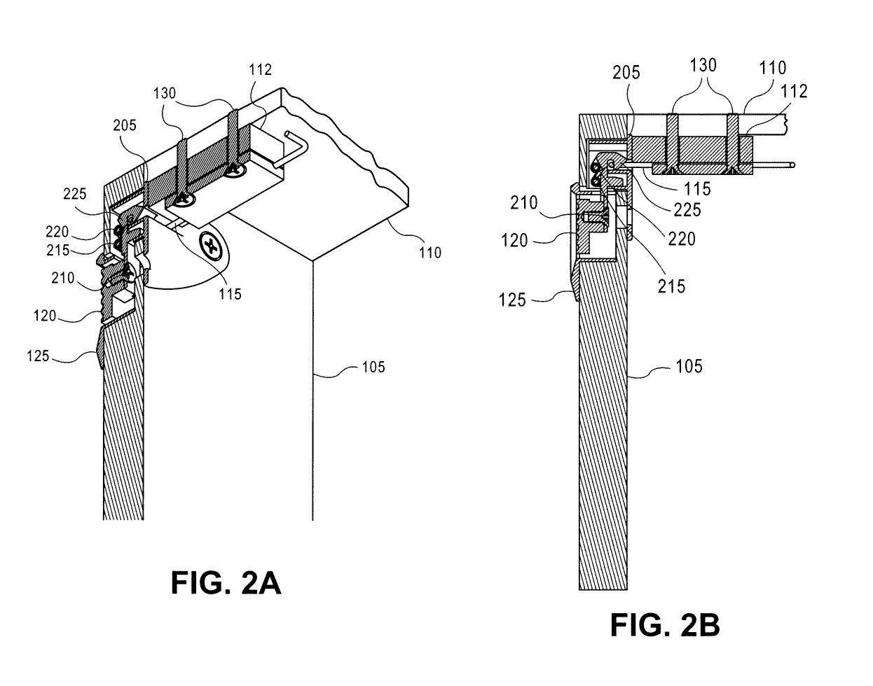

FIG. 2A illustrates a cross-sectional isometric view and FIG. 2B depicts a cross-sectional side view of one embodiment of a cabinet door and latch. In these views, the latch resides inside the first panel 105. The first panel 105 and the second panel 110 are positioned in the same manner as shown in FIGS. 1A and 1B, where the cabinet would be closed and the latch engaged. Engagement and disengagement of the latch will be described with reference to the hook 225, which pivots between an engaged position and a disengaged position. In other words, the hook 225 is in the engaged position when securing the striker 115 (corresponding to a closed orientation of the hook 225) and the hook 225 is in the disengaged position when releasing the striker 115 (corresponding to an open orientation of the hook 225).

To open the cabinet, a user presses the actuator button 120 situated within a bezel 125 on the exterior side of the first panel 105 of the cabinet door. An actuator contact 210 (interfacing with a boss for contact with the actuator button 120) residing on the other side of the actuator button 120 moves with the actuator button 120 to cause rotation of a cam 215 and cam follower 220. The cam to cam follower movement pivots a hook 225 from an engaged position to a disengaged position.

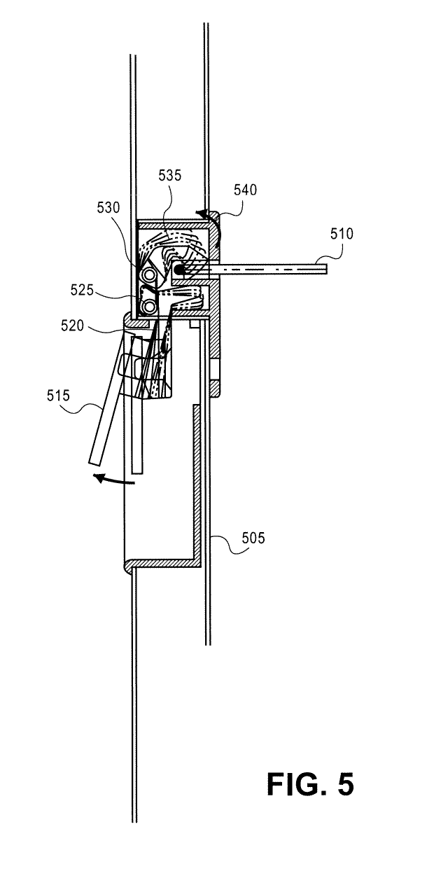

When the actuator is not activated, the hook 225 is biased in the engaged position by a biasing member that in one embodiment is a pair of torsion springs. One spring returns the actuator 120 to its rest position and the other spring returns the hook 225 to its rest (engaged) position. In the engaged position, the striker 115 is secured into place by the hook 225 inside the first panel 105. The striker can be released from the hook 225 inside the first panel 105 only when the hook 225 pivots to the disengaged position. While this embodiment is configured so that the hook 225 rotates towards the second panel 110, other embodiments can be configured so that the rotation of the cam 215 and cam follower 220 cause the hook 225 to pivot in a different direction, such as an opposite or sideways rotation. Further, an embodiment using a paddle actuator that requires a user to pull, rather than push, the actuator can be configured with a complementary cam and cam follower that causes the hook to pivot in the same direction depicted in FIG. 2B. This embodiment is illustrated in FIG. 5. The embodiments illustrated in FIGS. 2A, 2B, and 5 position the hook 225 to rotate in the direction as shown to maximize physical compactness of the overall latch.

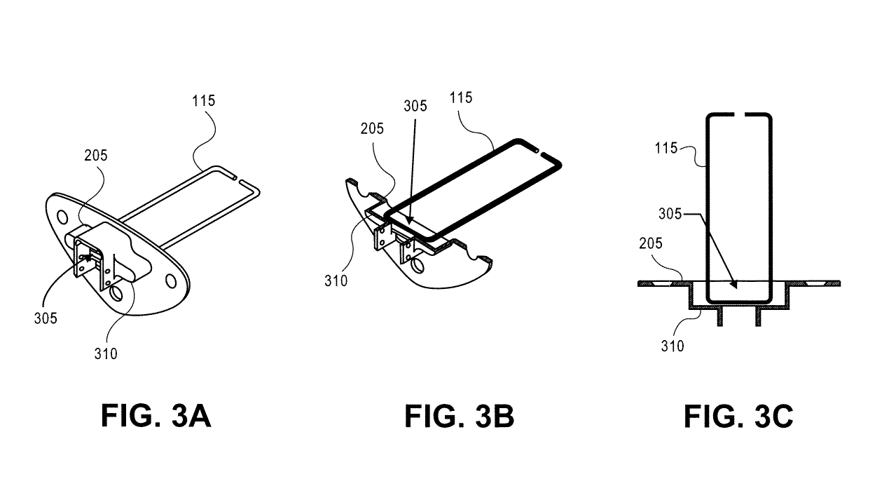

A housing 205 in the first panel 105 defines a pocket that retains the cam 215, the cam follower 220, and the hook 225. The pocket receives the portion of the striker 115 protruding from the second panel 110 when the cabinet is closed. The housing 205 conceals the moving parts of the latch inside the first panel 105 and away from view. The housing 205 provides an integrated striker stop to prevent the striker 115 from punching through the first panel 105, which is discussed in more detail with reference to FIGS. 3A, 3B, and 3C.

Turning to FIGS. 3A, 3B, and 3C, these drawings present a latch housing and striker showing the striker stop feature. FIG. 3A illustrates an exterior isometric view, FIG. 3B illustrates a cross-sectional isometric view, and FIG. 3C illustrates a cross-sectional top view of an embodiment of a striker stop and striker. The housing 205 defines a pocket 305 with an opening to receive a striker 115 to be engaged with a hook (not shown). When the striker 115 is inserted into the housing 205 and positioned as shown in FIGS. 3A, 3B, and 3C, the hook captures and secures the striker 115 so that the striker 115 cannot be removed from the housing 205 until a user initiates release of the hook by activating an actuator (not shown).

The latch housing 205 includes a distal wall 310 that serves as a physical barrier for the striker 115. Since the distal wall 310 prevents the striker 115 from traveling past the wall 310, the striker is not able to reach the exterior wall of the first panel and therefore cannot damage the first panel and any decorative coverings residing along the first panel, as well as any working parts that are in the way.

If a user exerts excessive force in slamming the cabinet shut, the striker 115 still cannot travel past the distal wall 310 of the housing 205 to damage any working parts of the latch, the cabinet door, or any decorative features on the cabinet door. If the striker 115 is misaligned when installed in the cabinet body and protrudes too far from the second panel, the striker 115 would have a tendency to travel past the position of the wall 310 and damage any parts in its path when the cabinet is closed. However, the wall 310 is positioned to preclude the striker 115 from causing this destruction and thus serves as a striker stop for the latch. If the striker 115 protrudes too far from the second panel, the cabinet will not close completely, but the latch will still secure the cabinet door in its displaced position.

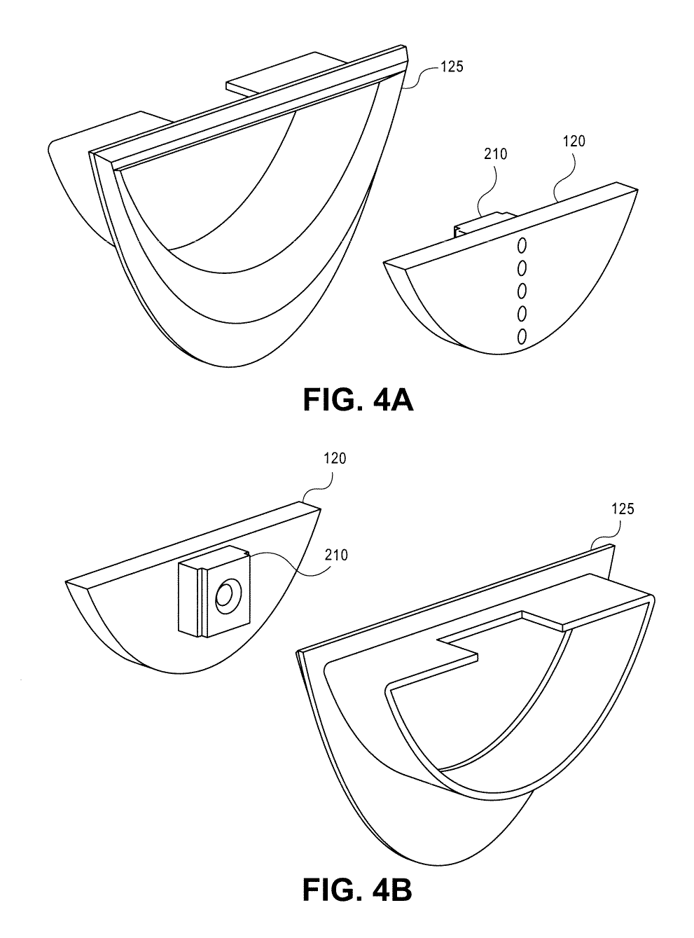

FIGS. 4A and 4B are views of one cosmetic version of a push button actuator and decorative bezel. FIG. 4A is a diagram of an exterior isometric view and FIG. 4B is a diagram of an interior isometric view of one embodiment of a button and bezel. The bezel 125 is a decorative piece that surrounds the button 120 and is for cosmetic purpose only. The button 120 is an actuator that initiates disengagement of a latch. The button 120 and bezel 125 can be formed as any shape, size, color, or material desired for aesthetic, ergonomic, or cost purposes. The button 120 and bezel 125 can be easily interchanged with other buttons and bezels without replacing the remaining assembly of the latch. The button 120 may be replaced by an actuator of a different type, such as a paddle or sensor actuator, as mentioned above. If the button 120 is secured to fit in the cabinet door, then a bezel 125 may not be required.

The button 120 in this embodiment has 5 decorative ovals on the exterior side, as viewed in FIG. 4A. The other side of the button 120 has an actuator contact 210 that is coupled with the button actuator 120 as well as the cam to cam follower assembly of the latch (not shown). The actuator contact 210 serves as an intermediate piece that transfers force initiated by a user on the button 120 to the cam to cam follower coupled with the hook.

FIG. 5 is a drawing of a cross-sectional side view of a paddle latch. The operation differs from a push button latch in movement, but the main structural pieces are similar to those illustrated in FIG. 2B. The latch is housed in a latch housing 540 in a first panel 505 of a cabinet door. The latch housing 540 provides the same striker stop protection described in connection with FIGS. 3A-3C.

To release the latch, a user pulls the actuator 515 in the direction shown by the arrow. Movement of the actuator 515 causes the actuator contact 520 to move in the same manner. The actuator contact 520 is coupled to a cam 525 that rotates and causes the cam follower 530 also to rotate. The cam follower 530 is coupled to a hook 535 that pivots with the rotation of the cam follower 530 between an engaged and disengaged position. When the hook 535 is in the engaged position, a striker 510 is secured in position inside the latch housing 540 of the first panel 505. When the hook 535 is in the disengaged position, the striker 510 is released from the hook 535 and can be removed from the latch housing 540 so that the cabinet can open.

It is noted that in the above embodiments, whether the actuator is a push button type or a paddle type, adjustment of the physical placement of the actuator changes its pivot point, affecting the degree in which the hook is rotated away from the striker when the actuator is pressed or pulled. For example, for the paddle type actuator 515 of FIG. 5, a user is precluded from pulling it past a certain point when either the top part of the paddle 515 is blocked by contact with the first panel 505 or the hook 535 is blocked by the ceiling of the latch housing 540. If the actuator 515 is placed too high, it is precluded by contact with the first panel 505 from rotating enough to allow the cam 525 and cam follower 530 to pivot the hook 535 with sufficient clearance to release the striker 510. Other adjustments may be made to change the amount of rotation allowed for an actuator, such as varying the depth of the hook, varying the width of the first panel, varying the size of the bezel, or varying the size of the striker.

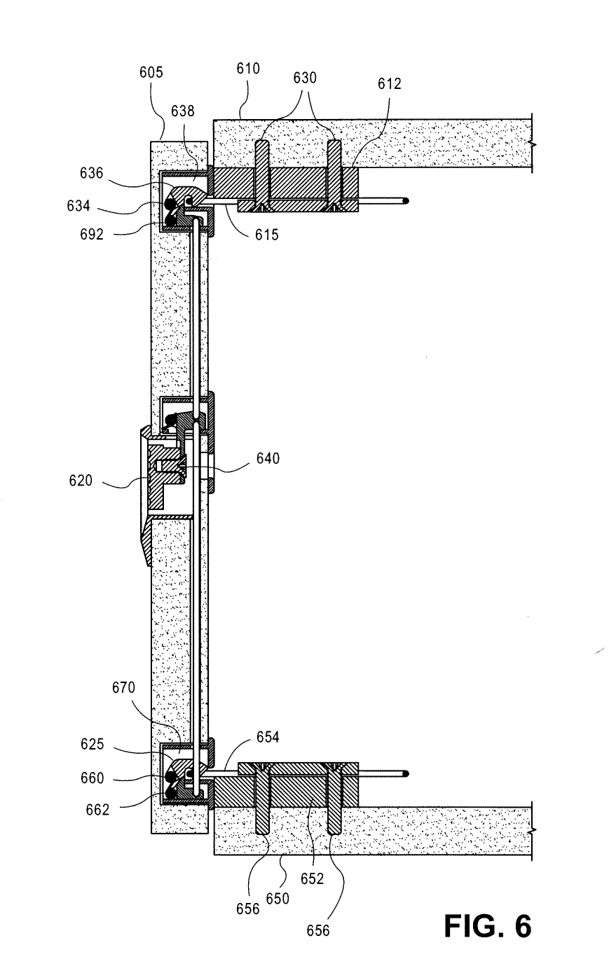

In additional embodiments, a cabinet door can have multiple latches individually corresponding to multiple actuators or simultaneously corresponding to a single actuator. For example, a tall door may include latches at the top and bottom of the door to enhance strength of closure and require a user to activate a top actuator and a bottom actuator at the same time to open the door. In another example, FIG. 6 depicts a two latch cabinet corresponding to a single actuator.

FIG. 6 adds a second latch to the existing latch of FIG. 2B. As illustrated also in FIG. 2B, a first panel 605 is coupled to a second top panel 610. The second top panel 610 can be a ceiling of a cabinet. The first panel 605 includes a top latch housing 638 that houses a top cam 692, a top cam follower 634, and a top hook 636. The top hook 636 receives a top striker 615 positioned against a second top panel 610 with a top spacer 612 and top screws or bolts 630.

The first panel 605 is also coupled to a third bottom panel 650 parallel to the second top panel 610. The third bottom panel 650 can be a bottom wall of a cabinet. The first panel 605 also includes a bottom latch housing 670 that houses a bottom cam 662, a bottom cam follower 662, and a bottom hook 664. The bottom hook 625 receives a bottom striker 654 positioned against the third bottom panel 650 using a bottom spacer 652 and bottom screws or bolts 656.

The top latch and the bottom latch rotate simultaneously with the push of the button actuator 620. The actuator contact 640 controls movement of both the top cam 692 and the bottom cam 662. In this embodiment, the actuator is a push button, but in other embodiments, a paddle may instead be used. The push button is centrally located and, when operated, releases both remotely located latch bolts. The movement of the button is transferred to the latch bolts via individual connecting rods. A single push button therefore pushes one rod and pulls another to release their respective strikers. In the alternative, individual connecting cables may be used instead of rods. These cams cause their respective cam followers 634, 660 and hooks 636, 625 to rotate and release the strikers 615, 654 attached to the top and bottom panels 610, 650. Both strikers 615, 654 are disengaged from the hooks 636, 625 before the cabinet can be opened.

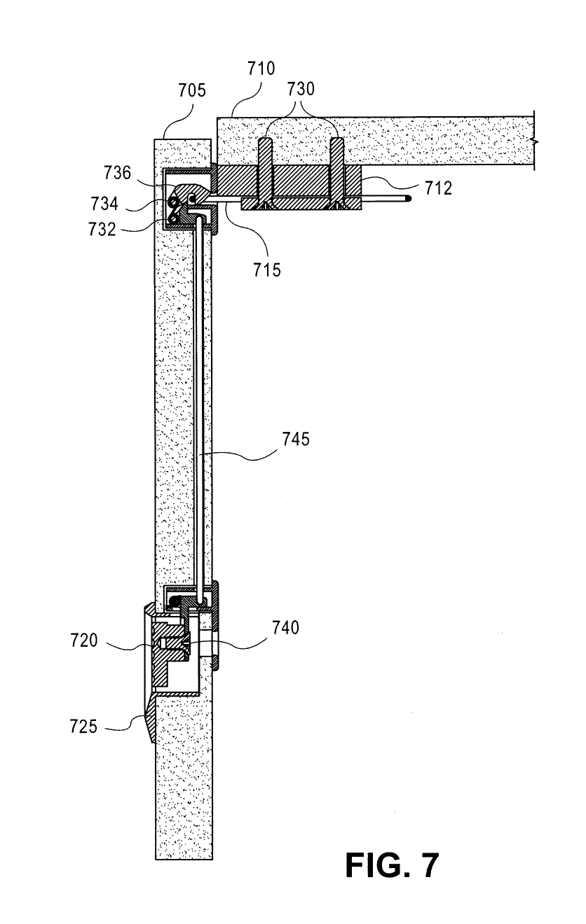

Furthermore, the actuator may be physically positioned a substantial distance away from where the working parts of the latch are located. In FIG. 7, the latch is configured similar to the latch of FIG. 2B, except the actuator is located near the bottom of the cabinet door. FIG. 7 includes a first panel 705 is coupled to a second panel 710. The first panel 705 includes a latch housing 738 that houses a cam 732, a cam follower 734, and a hook 736. The hook 736 receives a striker 715 positioned against a second panel 710 using a spacer 712 and screws or bolts 730. The push button actuator 720 is located within the bezel 725 near the bottom of the first panel 705 and coupled to an actuator contact 740 that is coupled to a rod 745 (or cable) that, in turn, rotates the cam 732, as similarly configured in FIG. 6. Thus, a user can press the actuator button 720 to release the latch and open the cabinet even when the latch is physically located quite a distance away from the button.

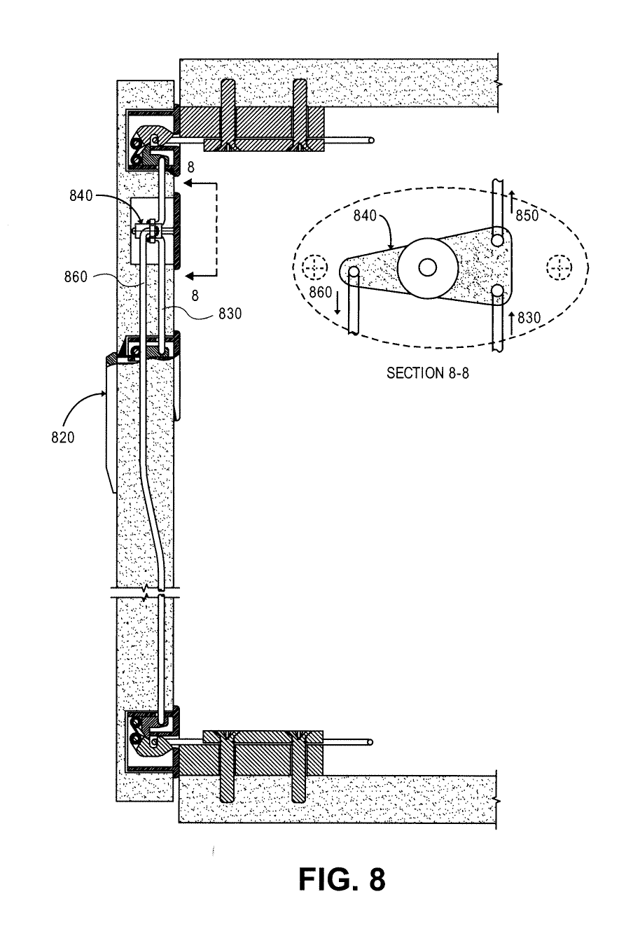

FIG. 8 is a diagram of a cross-sectional side view of one embodiment of a cabinet door using a bellcrank to release multiple bolts. This embodiment differs from FIG. 7 in that a bellcrank operation is utilized. Here, the actuator button 820 is pressed to move rod 830 upward. As mentioned above, the rods illustrated may alternatively be cables in another embodiment. The upward movement of rod 830 rotates bellcrank 840. As bellcrank 840 pivots, rod 850 is pushed upward, and at the same time, rod 860 is pushed downward. The upward movement of rod 850 releases the top bolt in the manner of FIG. 7. Likewise, the downward movement of rod 860 releases the bottom bolt in a mirrored manner of the top bolt.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

I claim:

1. A latch comprising:
an actuator;
a hook;
a striker to be engaged by the hook when the hook is in a closed orientation;
a cam and a cam follower to move the hook between an open orientation and the closed orientation responsive to activation of the actuator; and
a housing to retain the cam and the cam follower.

2. The latch of claim 1, wherein the housing defines a pocket to receive the striker and has a distal wall that provides an integrated striker stop to prevent striker punch through.

3. The latch of claim 1, wherein the actuator is one of a button and a paddle.

4. The latch of claim 1, further comprising:
a biasing member to bias the hook into the closed orientation.

5. The latch of claim 4, wherein the biasing member comprises a pair of torsion springs.

6. The latch of claim 1, further comprising:
a uniform actuator-cam interface to permit a plurality of alternative actuators to be used with the cam.

7. An apparatus comprising:
an enclosure having a first panel to be retained in proximity to a second panel by a first latch, the first latch including:
a first striker;
a first hook; and
a first cam and a first cam follower coupled to the first hook to rotate the first hook between an engaged position and a disengaged position, wherein the first hook, the first cam, and the first cam follower are positioned within a first recess defined by the first panel and aligned with a second recess defined by the second panel, the second recess in the second panel to receive the first striker; and
a first actuator coupled to the first panel, the first actuator to activate engagement and disengagement of the first hook and the first striker.

8. The apparatus of claim 7, wherein the first panel comprising:
an external side external to the apparatus and coupled to the first actuator; and
an internal side internal to the apparatus that defines a pocket to receive the striker, the internal side integrated with a striker stop to prevent the striker from punching through the first recess and to the external side.

9. The apparatus of claim 7, wherein the first actuator is one of a button and a paddle.

10. The apparatus of claim 7, wherein the enclosure further comprises:
a biasing member coupled to the cam and the first actuator, the biasing member to bias the hook into the engaged position.

11. The apparatus of claim 7, the biasing member comprises a pair of torsion springs.

12. The apparatus of claim 7, the enclosure further comprising:
a second latch to retain the first panel in proximity to the second panel, the second latch comprising:
a second striker;
a second hook; and
a second cam and a second cam follower coupled to the second hook to rotate the second hook between the engaged position and the disengaged position, wherein the second hook, the second cam, and the second cam follower are positioned within a third recess defined by the first panel and aligned with a fourth recess defined by the second panel, the fourth recess defined by the second panel to receive the second striker.

13. The apparatus of claim 12, wherein the first actuator to control movement of the first latch and the second latch simultaneously.

14. The apparatus of claim 12, further comprising:
a second actuator coupled to the first panel, the second actuator to activate engagement and disengagement of the second hook and the second striker, the second actuator to activate simultaneously with the first actuator to release attachment of the first panel and the second panel.
